(19) United States
(12) Patent Application Publication
(10) Pub. No.: US 2026/0014914 A1
(43) Pub. Date: Jan. 15, 2026

(54) LEG SUPPORT DEVICE FOR A SEAT AND A VEHICLE SEAT

(71) Applicant: Ford Global Technologies, LLC, Dearborn, MI (US)

(72) Inventors: Zu Wei Zhang, Nanjing (CN); Bao Lin Zhang, Nanjing (CN); Zhi Ma, Nanjing (CN)

(73) Assignee: Ford Global Technologies, LLC, Dearborn, MI (US)

(21) Appl. No.: 19/238,606

(22) Filed: Jun. 16, 2025

(30) Foreign Application Priority Data
Jul. 11, 2024 (CN) 202421636837.0

(51) Int. Cl. B60N 2/90; B60N 2/02

(52) U.S. Cl. CPC B60N 2/995; B60N 2/02253; B60N 2/02258

(57) ABSTRACT

A leg support device for a seat includes a bracket, a leg support mechanism, and two oppositely arranged linkage components. The two linkage components are respectively connected between the bracket and the leg support mechanism, and configured to guide the leg support mechanism to switch between a stowed state and an unfolded state. Each of the linkage components includes a first link and a second link that are pivotally connected by a pivot shaft. The first link is connected to the leg support mechanism and has an elongated hole and an elastic member. The pivot shaft is inserted into the elongated hole in a relatively movable manner, and the elastic member is arranged between the pivot shaft and the first link in an abutting manner. The force acting on the leg support device can be released by the compression deformation of the elastic member.

### CROSS-REFERENCE TO RELATED APPLICATION

This application claims foreign priority benefits under 35 U.S.C. § 119(a)-(d) to China Application No. 202421636837.0 filed Jul. 11, 2024, which is hereby incorporated by reference in its entirety.

### FIELD OF THE DISCLOSURE

The present disclosure generally relates to vehicle seating, and more particularly relates to a leg support device for a seat and a vehicle seat having the leg support device that may be used only when the vehicle is stationary and not moving.

### BACKGROUND OF THE DISCLOSURE

With the widespread use of vehicles, enhanced requirements for the comfort of vehicle seats have been put forward. Some vehicle seats are equipped with leg support devices, which have a stowed state and an unfolded state. When in the stowed state, the leg support device folds and is stored under the front of the seat. When in the unfolded state only while the vehicle is stationary and not moving, the leg support device unfolds forward and can support the legs of vehicle occupants. However, there is still room for further enhancement of vehicle seat leg support devices.

### SUMMARY OF THE DISCLOSURE

According to a first aspect of the present disclosure, a leg support device for a seat includes a bracket, a leg support mechanism, and two oppositely arranged linkage components that are respectively connected between the bracket and the leg support mechanism. The leg support mechanism is configured to guide the leg support mechanism to switch between a stowed state and an unfolded state. Each of the two oppositely arranged linkage components comprise a first link and a second link that are pivotally connected by a pivot shaft. The first link is connected to the leg support mechanism and has an elongated hole and an elastic member. The pivot shaft is inserted into the elongated hole in a relatively movable manner. The elastic member is arranged between the pivot shaft and the first link in an abutting manner.

Embodiments of the first aspect of the present disclosure can include any one or a combination of the following features:
the first link comprises a cavity with the elongated hole, and the elastic member is accommodated in the cavity;
the first link extends along a curve;
a connecting rod rotatably connected to the two oppositely arranged linkage components constituting the pivot shafts of the two oppositely arranged linkage components;
the leg support mechanism comprises multiple support members slidably connected in sequence, each support member having a U-shaped cross-section, and the leg support mechanism in the stowed state configured to at least partially accommodate the two oppositely arranged linkage components;
at least one driving mechanism for driving at least one support member to slide comprising a motor, a screw driven by the motor, and a threaded member that cooperates with the screw, the motor and the threaded member being respectively arranged on adjacent two support members;
a footrest is pivotally arranged at a front end of the leg support mechanism, wherein a receiving groove for receiving the footrest is provided on a support member located at the rear end;
each of the two oppositely arranged linkage components further comprises a third link and a fourth link that are pivotally connected to each other, the third link and the fourth link are respectively connected to the leg support mechanism and the bracket, and the third link has a middle portion that is rotatably connected to a middle portion of the second link; and
a driving mechanism for driving the two oppositely arranged linkage components to move comprising a fixed rod fixedly connected to the two oppositely arranged linkage components, and a motor arranged on the bracket and connected to the fixed rod for transmission, the motor driving the fixed rod to move away from or towards the motor.

According to a second aspect of the present disclosure, a vehicle seat has a seat cushion, a backrest, and a leg support device configured to extend outward from a front end of the vehicle seat while the vehicle is stationary and not moving. The leg support mechanism, and two oppositely arranged linkage components that are respectively connected between the bracket and the leg support mechanism. The leg support mechanism is configured to guide the leg support mechanism to switch between a stowed state and an unfolded state. Each of the two oppositely arranged linkage components comprise a first link and a second link that are pivotally connected by a pivot shaft. The first link is connected to the leg support mechanism and has an elongated hole and an elastic member. The pivot shaft is inserted into the elongated hole in a relatively movable manner. The elastic member is arranged between the pivot shaft and the first link in an abutting manner.

Embodiments of the second aspect of the present disclosure can include any one or a combination of the following features:
the first link comprises a cavity with the elongated hole, and the elastic member is accommodated in the cavity;
the first link extends along a curve;
a connecting rod rotatably connected to the two oppositely arranged linkage components constituting the pivot shafts of the two oppositely arranged linkage components;
the leg support mechanism comprises multiple support members slidably connected in sequence, each support member having a U-shaped cross-section, and the leg support mechanism in the stowed state configured to at least partially accommodate the two oppositely arranged linkage components;
at least one driving mechanism for driving at least one support member to slide comprising a motor, a screw driven by the motor, and a threaded member that cooperates with the screw, the motor and the threaded member being respectively arranged on adjacent two support members;
a footrest is pivotally arranged at a front end of the leg support mechanism, wherein a receiving groove for receiving the footrest is provided on a support member located at the rear end;
each of the two oppositely arranged linkage components further comprises a third link and a fourth link that are pivotally connected to each other, the third link and the fourth link are respectively connected to the leg support mechanism and the bracket, and the third link has a middle portion that is rotatably connected to a middle portion of the second link; and
a driving mechanism for driving the two oppositely arranged linkage components to move comprising a fixed rod fixedly connected to the two oppositely arranged linkage components, and a motor arranged on the bracket and connected to the fixed rod for transmission, the motor driving the fixed rod to move away from or towards the motor.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a front perspective view of a vehicle seat having a deployed leg support device according to an embodiment of the present disclosure;

FIG. 2 is a schematic side view of the leg support device showing the leg support mechanism in a stowed state;

FIG. 3 is a schematic side view of the leg support device showing the leg support mechanism in an unfolded state;

FIG. 4 is a schematic side view of the leg support device showing the leg support mechanism in an extended state;

FIG. 5 is a schematic side view of the leg support device showing an elastic member in a compressed state; and

FIG. 6 is a lower perspective view of the leg support device as shown in FIG. 4.

### DETAILED DESCRIPTION OF PREFERRED EMBODIMENTS

Reference will now be made in detail to the present preferred embodiments of the disclosure, examples of which are illustrated in the accompanying drawings. Wherever possible, the same reference numerals will be used throughout the drawings to refer to the same or like parts. In the drawings, the depicted structural elements are not to scale and certain components are enlarged relative to the other components for purposes of emphasis and understanding.

As required, detailed embodiments of the present disclosure are disclosed herein; however, it is to be understood that the disclosed embodiments are merely exemplary of the disclosure that may be embodied in various and alternative forms. The figures are not necessarily to a detailed design; some schematics may be exaggerated or minimized to show function overview. Therefore, specific structural and functional details disclosed herein are not to be interpreted as limiting, but merely as a representative basis for teaching one skilled in the art to variously employ the present disclosure.

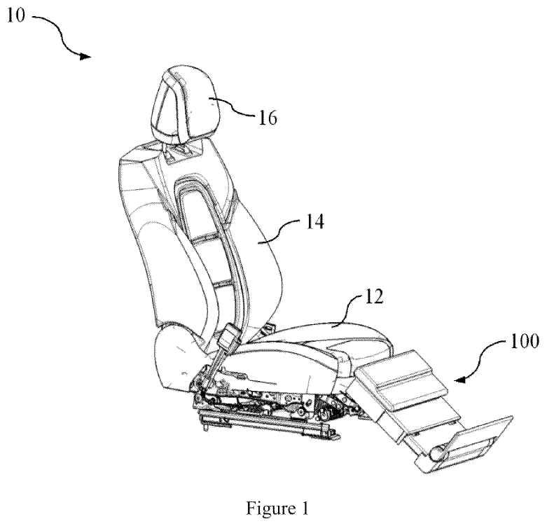

For purposes of description herein, the terms “upper,” “lower,” “right,” “left,” “rear,” “front,” “vertical,” “horizontal,” and derivatives thereof shall relate to the concepts as oriented in FIG. 1. However, it is to be understood that the concepts may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The present illustrated embodiments reside primarily in combinations of method steps and apparatus components related to a leg support device for a vehicle seat. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

As used herein, the term “and/or,” when used in a list of two or more items, means that any one of the listed items can be employed by itself, or any combination of two or more of the listed items, can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

Vehicles involved in the following embodiments may be motor vehicles such as standard gasoline powered vehicles, hybrid vehicles, electric vehicles, fuel cell vehicles, two-or three-wheeled vehicles, ships, aircraft, and/or any other type of vehicles. The vehicle includes components related to mobility, such as engine, electric motor, transmission, suspension, driveshaft, and/or wheels. The vehicle also includes components related to vehicle control, such as vehicle controllers, vehicle buses, etc. The vehicle controller can be connected to the internal components of the vehicle through the vehicle bus to achieve the control of these components. The vehicle can be non-autonomous, semi-autonomous (for example, some conventional motion functions are controlled by the vehicle), or autonomous (for example, motion functions are controlled by the vehicle without direct input from user).

This disclosure provides for further enhancement in the reliability of the existing leg support devices. Specifically, due to differences in body shape, weight, and other factors among vehicle occupants, the leg support devices may be subjected to varying degrees of force from different vehicle occupants during use. This requires the leg support devices to have sufficient resistance to handle large forces. In addition, unintended use by the vehicle occupants may put higher demands on the structural strength of the leg support devices. For example, the vehicle occupants may rest on the leg support devices with greater intensity, or shake or jiggle on the leg support devices, or place extra heavy objects on their legs. All these behaviors may cause the leg support devices to bear greater force. Therefore, it is desirable to further enhance the ability of the leg support devices to withstand larger forces. In addition, the vehicle occupants of different body shapes also put forward different requirements for the support length of the leg support devices. In order to meet the comfort needs of the vast majority of users, it is desirable to provide adjustability of the support length.

FIG. 1 shows a schematic perspective view of a vehicle seat 10 according to an embodiment of the present disclosure. Referring to FIG. 1, the vehicle seat 10 may include a seat cushion 12 which provides the seat base, a backrest 14, a headrest 16, and a leg support device 100. The vehicle seat 10 can be a front seat or a rear seat. In some embodiments, for the comfort of the vehicle occupants, the vehicle seat 10 provides adjustability in terms of inclination of the seat cushion 12, inclination of the backrest 14, height of the headrest 16, and other aspects. In the embodiment of the present disclosure, the vehicle seat 10 is equipped with the leg support device 100 to provide the function of relaxing the lower leg. As shown in FIG. 1, the leg support device 100 can extend outward from the lower front end of the vehicle seat 10, particularly from the front end of the seat cushion 12 to support the lower leg while the vehicle is stationary and not moving. Those skilled in the art should understand that in addition to being used for the vehicle seat 10, the leg support device 100 can also be applied to various other suitable seats.

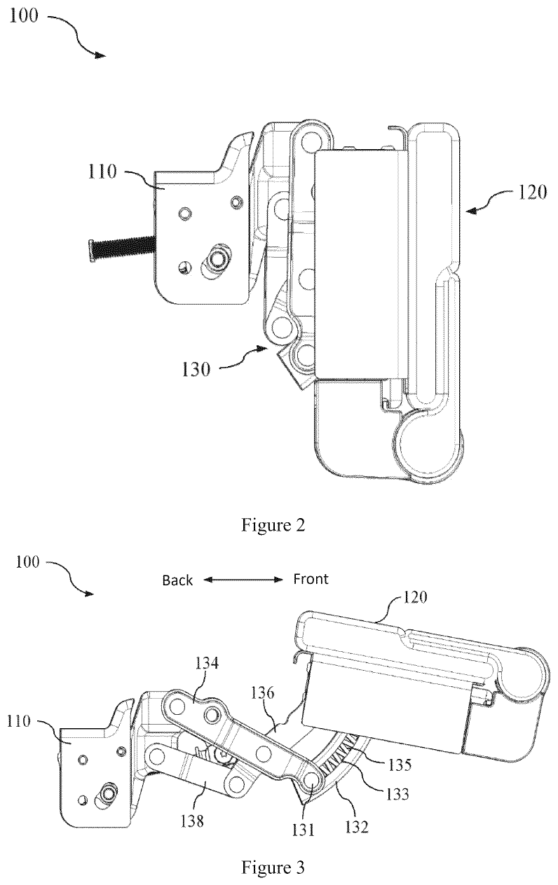

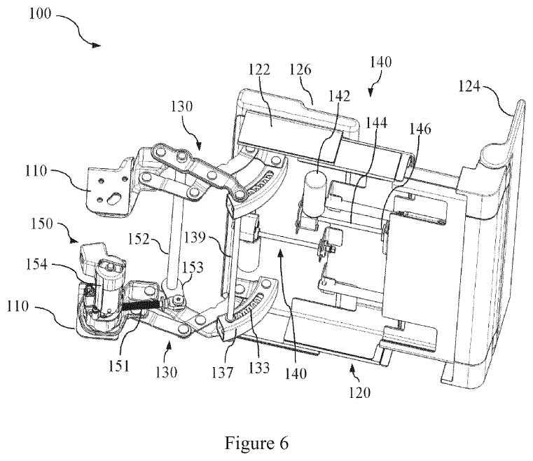

FIG. 2 shows a schematic perspective view of a leg support mechanism 120 of the leg support device 100 in a stowed state, FIG. 3 shows a schematic perspective view of the leg support mechanism 120 of the leg support device 100 in an unfolded state, and FIG. 6 further shows a schematic perspective view of the leg support device 100 from another perspective. Referring to FIGS. 2, 3, and 6, the leg support device 100 includes a bracket 110, a leg support mechanism 120, and two oppositely arranged linkage components 130. The two linkage components 130 are respectively connected between the bracket 110 and the leg support mechanism 120, and configured to guide the leg support mechanism 120 to switch between the stowed state and the unfolded state. As shown in FIG. 2, the linkage components 130 are folded to put the leg support mechanism 120 in the stowed state. At this point, the leg support mechanism 120 is close to the bracket 110 and extends roughly up and down. The entire leg support device 100 is folded into a compact structure and stored on the front lower side of the seat cushion 12, releasing the space on the front side of the seat cushion 12. As shown in FIG. 3, the linkage components 130 are unfolded to place the leg support mechanism 120 in the unfolded state. At this point, the leg support mechanism 120 extends forward and roughly back and forth to support the user's legs.

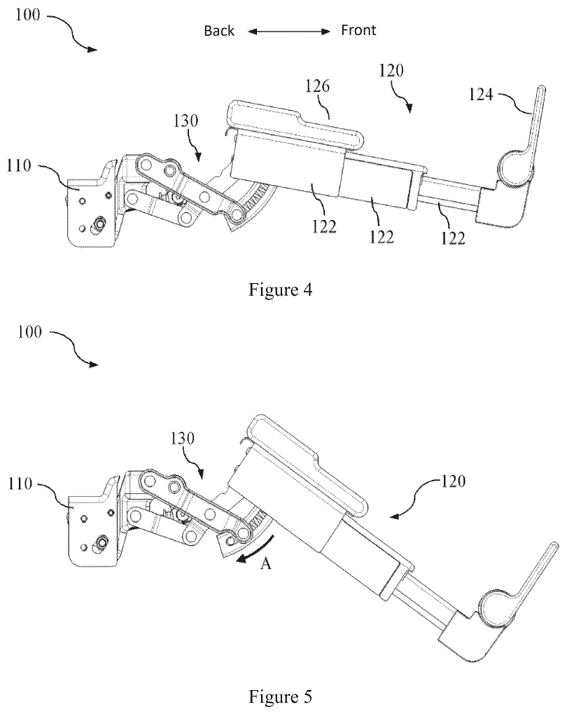

Referring to FIGS. 3 to 6, in the embodiment of the present disclosure, each of the linkage components 130 includes a first link 132 and a second link 134 that are pivotally connected by a pivot shaft 131. The first link 132 is connected to the leg support mechanism 120 and has an elongated hole 133 and an elastic member 135 shown in one embodiment configured as a spring, such as a compression spring, for example. The pivot shaft 131 is inserted into the elongated hole 133 in a relatively movable manner, and the elastic member 135 is arranged between the pivot shaft 131 and the first link 132 in an abutting manner. The elongated hole 133 and the clastic member 135 can extend along an extension direction of the first link 132. One end of the first link 132 is pivotally connected to the second link 134 through the pivot shaft 131, and the other end is pivotally connected to the leg support mechanism 120. The elastic member 135 extends between the two ends of the first link 132. One end of the second link 134 is pivotally connected to the first link 132 through the pivot shaft 131, and the other end can be pivotally connected to the bracket 110. The pivot shaft 131 is inserted into the elongated hole 133 in a relatively movable manner, so that the pivot shaft 131 and the first link 132 can move relative to each other to allow the elastic member 135 between them to be compressed. As shown in FIGS. 3 and 4, in the normal state where the force acting on the leg support mechanism 120 is less than a critical value, the elastic member 135 is in an extended state and holds the pivot shaft 131 at one end of the elongated hole 133. As shown in FIG. 5, when the leg support mechanism 120 is subjected to a force greater than the critical value (such as about 890N), the elastic member 135 can be compressed to release the force, protecting the leg support device 100 from being affected by excessive force. At this time, the first link 132 moves downward along the extension direction of the first link 132 relative to the pivot shaft 131 as indicated by the arrow A, and the pivot shaft 131 moves upward within the elongated hole 133. Moreover, the downward movement of the first link 132 causes the leg support mechanism 120 to rotate downwards, which can change the direction of the force acting on the leg support mechanism 120, reducing the force perpendicular to its surface and achieving the effect of force relief. In some embodiments, the linkage component 130 is connected to the leg support mechanism 120 at two connection points, wherein the first link 132 is connected to the front connection point of the two. When the first link 132 drives the front connection point to move downward, the leg support mechanism 120 can rotate downward around the rear connection point.

Referring to FIGS. 3 and 6, in some embodiments, the first link 132 includes a cavity 137 with the elongated hole 133, and the elastic member 135 is accommodated in the cavity 137. By providing the first link 132 to include the cavity 137, on the one hand, it can store and protect the elastic member 135, and on the other hand, it can provide good guidance to guide the elastic member 135 to expand and contract along the extension direction of the cavity 137. In addition, compared to sheet-like or plate-shaped links, the first link 132 with the cavity 137 can have better structural strength, which is conducive to enhancing support stability and thus enhancing the overall reliability of the leg support device 100. The elongated hole 133 can be formed in a side surface of the cavity 137, and the pivot shaft 131 extends into the cavity 137 through the elongated hole 133 and engages with one end of the elastic member 135. The other end of the elastic member 135 can be pressed against an end wall of the cavity 137. The cavity 137 may have a cross-section of square, circular, or other shapes.

Referring to FIG. 3, in some embodiments, the first link 132 extends along a curve, such as an arc. The first link 132 extending along the curve can be longer than the link extending along a straight line, which can reserve more space for the arrangement of the elastic member 135, making it easier for the clastic member 135 to be fully compressed to release more force, and at the same time, the selection of the elastic member 135 can be less restricted. Moreover, extending along the curve can make the structure compact, which is beneficial for reducing the occupied space.

Referring to FIG. 6, in some embodiments, the leg support device 100 further includes a connecting rod 139 that is rotatably connected to the two linkage components 130, and the connecting rod 139 constitutes the pivot shafts 131 of the two linkage components 130. The two linkage components 130 share the connecting rod 139, ensuring the synchronization of the movement of the two linkage components 130 and the synchronous compression of the two clastic members 135, thereby uniformly and smoothly releasing the force.

Referring to FIG. 3, in some embodiments, each of the linkage components 130 further includes a third link 136 and a fourth link 138 that are pivotally connected to each other. The third link 136 and the fourth link 138 are respectively connected to the leg support mechanism 120 and the bracket 110, and the middle portion of the third link 136 is rotatably connected to the middle portion of the second link 134. Each of the linkage components 130 is generally W-shaped, and includes two intersecting V-shaped structures. One V-shaped structure is formed by the first link 132 and the second link 134, while the other V-shaped structure is formed by the third link 136 and the fourth link 138. The connection point of the first link 132 on the leg support mechanism 120 is located in front of the connection point of the third link 136 on the leg support mechanism 120. The connection point of the second link 134 on the bracket 110 is located in front of the connection point of the fourth link 138 on the bracket 110.

Referring to FIG. 6, in some embodiments, the leg support device 100 further includes a driving mechanism 140 for driving the two linkage components 130 to move. The driving mechanism 140 includes a fixed rod 152 fixedly connected to the two linkage components 130, and a motor 154 arranged on the bracket 110 and connected to the fixed rod 152 for transmission. The motor 154 drives the fixed rod 152 to move away from or towards the motor 154. When the motor 154 drives the fixed rod 150 to move away from the motor 154 (such as pushing the fixed rod 150 forward), the two linkage components 130 unfold and guide the leg support mechanism 120 to switch to the unfolded state. When the motor 154 drives the fixed rod 150 to move towards the motor 154 (such as pulling the fixed rod 150 backwards), the two linkage components 130 fold and guide the leg support mechanism 120 to switch to the stowed state. The driving mechanism 140 may include a push rod 151 and a connecting piece 153. The motor 154 drives the push rod 151 to move in a straight line. One end of the connecting piece 153 is rotatably connected to the push rod 151, and the other end is connected to the fixed rod 152.

FIG. 4 shows a schematic side view of the leg support mechanism 120 of the leg support device 100 according to an embodiment of the present disclosure in the extended state. The leg support mechanism 120 can be further adjusted from the unfolded state in FIG. 3 to the extended state in FIG. 4. Referring to FIG. 4, in some embodiments, the leg support mechanism 120 includes multiple support members 122 slidably connected in sequence, making the leg support mechanism 120 telescopic, so that its length is adjustable. This allows the suitable support length to be adjusted according to the body shape of different users, ensuring good adaptability of the leg support device 100. A groove can be provided on the support member 122 to guide the sliding. As shown in FIG. 4, the leg support mechanism 120 includes three support members 122 and can achieve two-stage telescoping, providing a relatively wide adjustable length range. It should be appreciated that those skilled in the art can set the number of support members 122 according to actual needs.

Referring to FIGS. 2 and 6, in some embodiments, each support member 122 has a U-shaped cross-section and includes a base plate and two side plates extending from opposite sides of the base plate. The leg support mechanism 120 in the stowed state can at least partially accommodate the two linkage components 130, so that the leg support mechanism 120 can protect the linkage components 130 while shielding internal structures such as the linkage components 130, providing a more aesthetic appearance.

Referring to FIG. 6, in some embodiments, the leg support device 100 further includes at least one driving mechanism 140 for driving at least one support member 122 to slide. The driving mechanism 140 includes a motor 142, a screw 144 driven by the motor 142, and a threaded member 146 that cooperates with the screw 144. The motor 142 and the threaded member 146 are respectively arranged on adjacent two support members 122. The motor 142 drives the screw 144 to rotate, and the screw 144 drives the threaded member 146 to move linearly along the screw 144 to approach or move away from the motor 142, so that the support members 122 where the threaded member 146 is located can telescope and slide relative to the support members where the motor 142 is located. In the embodiment shown in FIG. 6, the leg support mechanism 120 includes three support members 122, and two driving mechanism 140 are provided. The motor 142 and the threaded member 146 of one driving mechanism 140 are respectively arranged on the first and second support member 122, and the motor 142 and the threaded member 146 of the other driving mechanism 140 are respectively arranged on the second and third support member 122.

Referring to FIG. 4, the leg support device 100 further includes a footrest 124 that is pivotally arranged at the front end of the leg support mechanism 120. The footrest 124 has a stowed state that conforms to the leg support mechanism 120 and a deployed state that forms a predetermined angle relative to the leg support mechanism 123 to support the user's feet. Referring to FIGS. 2 and 4, a receiving groove 126 for receiving the footrest 124 is provided on the support member 122 located at the rear end, so that the footrest 124 in the stowed state is flush with the surface of the support member 122, achieving a more aesthetic appearance and a more compact structure.

The present disclosure provides a leg support device for a seat and a vehicle seat. Through the technical solution of the present disclosure, the force acting on the leg support device can be released by the compression deformation of the elastic member, enhancing the structural strength of the leg support device.

According to an aspect of the present disclosure, a leg support device for a seat is provided. The leg support device includes a bracket, a leg support mechanism, and two oppositely arranged linkage components. The two linkage components are respectively connected between the bracket and the leg support mechanism, and configured to guide the leg support mechanism to switch between a stowed state and an unfolded state. Each of the linkage components includes a first link and a second link that are pivotally connected by a pivot shaft. The first link is connected to the leg support mechanism and has an elongated hole and an elastic member. The pivot shaft is inserted into the elongated hole in a relatively movable manner, and the elastic member is arranged between the pivot shaft and the first link in an abutting manner.

According to another aspect of the present disclosure, the first link comprises a cavity with the elongated hole, and the elastic member is accommodated in the cavity.

According to another aspect of the present disclosure, the first link extends along a curve.

According to another aspect of the present disclosure, the leg support device further comprises a connecting rod rotatably connected to the two linkage components, and the connecting rod constitute the pivot shafts of the two linkage components.

According to another aspect of the present disclosure, the leg support mechanism comprises multiple support members slidably connected in sequence, each support member has a U-shaped cross-section, and the leg support mechanism in the stowed state can at least partially accommodate the two linkage components.

According to another aspect of the present disclosure, the leg support device further comprises at least one driving mechanism for driving at least one support member to slide. The driving mechanism comprises a motor, a screw driven by the motor, and a threaded member that cooperates with the screw. The motor and the threaded member are respectively arranged on adjacent two support members.

According to yet another aspect of the present disclosure, the leg support device further comprises a footrest that is pivotally arranged at the front end of the leg support mechanism, and a receiving groove for receiving the footrest is provided on the support member located at the rear end.

According to a further aspect of the present disclosure, each of the linkage components further comprises a third link and a fourth link that are pivotally connected to each other. The third link and the fourth link are respectively connected to the leg support mechanism and the bracket, and the third link has a middle portion that is rotatably connected to a middle portion of the second link.

According to yet a further aspect of the present disclosure, the leg support device further comprises a driving mechanism for driving the two linkage components to move. The driving mechanism comprises a fixed rod fixedly connected to the two linkage components, and a motor arranged on the bracket and connected to the fixed rod for transmission. The motor drives the fixed rod to move away from or towards the motor.

According to yet another aspect of the present disclosure, a vehicle seat comprising the leg support device as described in any of the above embodiments is provided.

It should be understood that, on the premise of technical feasibility, the technical features listed above for different embodiments can be combined with each other to form further embodiments within the scope of the present disclosure. In addition, the specific examples and embodiments described herein are non-limiting, and corresponding modifications can be made to the structure, dimensions, and materials described above without departing from the scope of protection of the present disclosure.

It is to be understood that variations and modifications can be made on the aforementioned structure without departing from the concepts of the present disclosure, and further it is to be understood that such concepts are intended to be covered by the following claims unless these claims by their language expressly state otherwise.

What is claimed is:

1. A leg support device for a seat, the leg support device comprising:
a bracket;
a leg support mechanism; and
two oppositely arranged linkage components that are respectively connected between the bracket and the leg support mechanism, and configured to guide the leg support mechanism to switch between a stowed state and an unfolded state, wherein each of the two oppositely arranged linkage components comprises a first link and a second link that are pivotally connected by a pivot shaft, wherein the first link is connected to the leg support mechanism and has an elongated hole and an elastic member, wherein the pivot shaft is inserted into the elongated hole in a relatively movable manner, and wherein the elastic member is arranged between the pivot shaft and the first link in an abutting manner.

2. The leg support device according to claim 1, wherein the first link comprises a cavity with the elongated hole, and the elastic member is accommodated in the cavity.

3. The leg support device according to claim 1, wherein the first link extends along a curve.

4. The leg support device according to claim 1, further comprising a connecting rod rotatably connected to the two oppositely arranged linkage components, the connecting rod constituting the pivot shafts of the two oppositely arranged linkage components.

5. The leg support device according to claim 1, wherein the leg support mechanism comprises multiple support members slidably connected in sequence, each support member having a U-shaped cross-section, and the leg support mechanism in the stowed state configured to at least partially accommodate the two oppositely arranged linkage components.

6. The leg support device according to claim 5, further comprising at least one driving mechanism for driving at least one support member to slide, the driving mechanism comprising a motor, a screw driven by the motor, and a threaded member that cooperates with the screw, the motor and the threaded member being respectively arranged on adjacent two support members.

7. The leg support device according to claim 5, further comprising a footrest that is pivotally arranged at a front end of the leg support mechanism, wherein a receiving groove for receiving the footrest is provided on a support member located at the rear end.

8. The leg support device according to claim 1, wherein each of the two oppositely arranged linkage components further comprises a third link and a fourth link that are pivotally connected to each other, the third link and the fourth link are respectively connected to the leg support mechanism and the bracket, and the third link has a middle portion that is rotatably connected to a middle portion of the second link.

9. The leg support device according to claim 1, further comprising a driving mechanism for driving the two oppositely arranged linkage components to move, the driving mechanism comprising a fixed rod fixedly connected to the two oppositely arranged linkage components, and a motor arranged on the bracket and connected to the fixed rod for transmission, the motor driving the fixed rod to move away from or towards the motor.

10. A vehicle seat comprising:
a seat cushion;
a backrest; and
a leg support device configured to extend outward from a front end of the vehicle seat, the leg support device comprising:
a bracket;
a leg support mechanism; and
two oppositely arranged linkage components that are respectively connected between the bracket and the leg support mechanism, and configured to guide the leg support mechanism to switch between a stowed state and an unfolded state, wherein each of the two oppositely arranged linkage components comprises a first link and a second link that are pivotally connected by a pivot shaft, wherein the first link is connected to the leg support mechanism and has an elongated hole and an elastic member, wherein the pivot shaft is inserted into the elongated hole in a relatively movable manner, and wherein the elastic member is arranged between the pivot shaft and the first link in an abutting manner.

11. The vehicle seat according to claim 10, wherein the first link comprises a cavity with the elongated hole, and the elastic member is accommodated in the cavity.

12. The vehicle seat according to claim 10, wherein the first link extends along a curve.

13. The vehicle seat according to claim 10, further comprising a connecting rod rotatably connected to the two oppositely arranged linkage components, the connecting rod constituting the pivot shafts of the two oppositely arranged linkage components.

14. The vehicle seat according to claim 10, wherein the leg support mechanism comprises multiple support members slidably connected in sequence, each support member having a U-shaped cross-section, and the leg support mechanism in the stowed state configured to at least partially accommodate the two oppositely arranged linkage components.

15. The vehicle seat according to claim 14, further comprising at least one driving mechanism for driving at least one support member to slide, the driving mechanism comprising a motor, a screw driven by the motor, and a threaded member that cooperates with the screw, the motor and the threaded member being respectively arranged on adjacent two support members.

16. The vehicle seat according to claim 14, further comprising a footrest that is pivotally arranged at a front end of the leg support mechanism, wherein a receiving groove for receiving the footrest is provided on a support member located at the rear end.

17. The vehicle seat according to claim 10, wherein each of the two oppositely arranged linkage components further comprises a third link and a fourth link that are pivotally connected to each other, the third link and the fourth link are respectively connected to the leg support mechanism and the bracket, and the third link has a middle portion that is rotatably connected to a middle portion of the second link.

18. The vehicle seat according to claim 10, further comprising a driving mechanism for driving the two oppositely arranged linkage components to move, the driving mechanism comprising a fixed rod fixedly connected to the two oppositely arranged linkage components, and a motor arranged on the bracket and connected to the fixed rod for transmission, the motor driving the fixed rod to move away from or towards the motor.
